(19) United States
(12) Patent Application Publication
(10) Pub. No.: US 2008/0215199 A1
(43) Pub. Date: Sep. 4, 2008

(54) VEHICLE-USE DUAL VOLTAGE TYPE POWER SUPPLY APPARATUS

(75) Inventors: Kiyoshi Aoyama, Okazaki-shi (JP); Hiroshi Tamura, Nagoya (JP); Akira Kato, Anjo-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/957,729

(22) Filed: Dec. 17, 2007

(30) Foreign Application Priority Data
Dec. 18, 2006 (JP) 2006-339925

(51) Int. Cl. B60L 11/02

(52) U.S. Cl. 701/22

(57) ABSTRACT

The vehicle-use dual voltage type power supply apparatus including a high voltage power supply system and a low voltage power supply system has a configuration that the target power generation cost is calculated individually for each of the two power supply systems in accordance with SOC as a variable of its own battery, so that the electricity cost reduction type power generation control can be performed individually for each of the two power supply systems.

### CROSS-REFERENCE TO RELATED APPLICATION

This application is related to Japanese Patent Application No. 2006-339925 filed on Dec. 18, 2006, the contents of which are hereby incorporated by reference.

### BACKGROUND OF THE INVENTION

1. Field of the Invention

The present invention relates to a vehicle-use power supply apparatus including a plurality of power supply systems each having a generator and a battery, and each operating to supply different voltages.

2. Description of Related Art

The importance of improving vehicle fuel consumption is increasing more and more in recent years because of the soaring fuel price. In order to improve vehicle fuel consumption, the applicant of this invention has proposed the electricity cost reduction type power generation control in which a target power generation cost CP is calculated as a function of an SOC (State Of Charge) of a battery, and electric power generation by a generator is boosted when a power generation cost Cg is lower than the calculated target power generation cost CP, while the electric power generation is restricted when the power generation cost Cg is higher than the calculated target power generation cost CP. In this the electricity cost reduction type power generation control, when the power generation cost Cg is low, the battery is charged by the boosted generation power, and when the power generation cost Cg is high, electric power accumulated in the battery is used to supplement the restricted generation power. For more details, refer to Japanese Patent Application Laid-open No. 2004-260908, for example.

Meanwhile, it is proposed, for example, in Japanese Patent Application laid-open No. 2001-309574 to provide a vehicle with a dual voltage type power supply apparatus. This dual voltage type power supply apparatus includes a high voltage power supply system having a high voltage generator and a high voltage battery for supplying a high power supply voltage to high voltage loads, a low voltage power supply system having a low voltage generator and a low voltage battery for supplying a low power supply voltage to low voltage loads, and a DC/DC converter enabling electric power transmission between these power supply systems. According to the dual voltage type power supply apparatus enabling relatively large loads to be powered by a high voltage, it becomes possible to reduce power loss to improve fuel consumption.

Attempts have been made to apply the previously described electricity cost reduction type power generation control to such a dual voltage type power supply apparatus with expectations of improving fuel consumption. However, the results of improving fuel consumption have fallen short of the expectations. This seems due to that the electricity cost reduction type power generation control cannot be simply applied as it is to a power supply apparatus including a plurality of generators and batteries.

### SUMMARY OF THE INVENTION

The present invention provides a vehicle-use dual voltage type power supply apparatus comprising:

a high voltage generator driven by a vehicle engine;

a low voltage generator driven by the vehicle engine;

a high voltage battery charged by the high voltage generator and connected with a high voltage load;

a low voltage battery charged by the low voltage generator and connected with a low voltage load; and

a control section controlling power generating operations of the high voltage generator and the low voltage generator;

the high voltage generator and the high voltage battery constituting a high voltage power supply system, and the low voltage generator and the low voltage battery constituting a low voltage power supply system,

wherein the control section

stores therein, as a low voltage side cost-SOC correlation, a negative correlation between a low voltage side target power generation cost and an SOC of the low voltage battery,

stores therein, as a high voltage side cost-SOC correlation, a negative correlation between a high voltage side target power generation cost and an SOC of the high voltage battery,

determines the SOC of the high voltage battery based on a charging/discharging current of the high voltage battery, and the SOC of the low voltage battery based on a charging/discharging current of the low voltage battery,

determines the low voltage side target power generation cost based on the low voltage side cost-SOC correlation and the SOC of the low voltage battery, and the high voltage side target power generation cost based on the high voltage side cost-SOC correlation and the SOC of the high voltage battery,

performs a comparison between the low voltage side target power generation cost and the high voltage side target power generation cost,

when the high voltage side target power generation cost is lower than the low voltage side target power generation cost, performs a high voltage side preferential power distribution process in which electric power to be generated by the high voltage generator is determined, as a high voltage side generation power, within a predetermined range depending on the high voltage side target power generation cost, and then electric power to be generated by the low voltage generator is determined, as a low voltage side generation power, within a predetermined range depending on the low voltage side target power generation cost, and

when the high voltage side target power generation cost is not lower than the low voltage side target power generation cost, performs a low voltage side preferential power distribution process in which electric power to be generated by the low voltage generator is determined, as the low voltage side generation power, within a predetermined range depending on the low voltage side target power generation cost, and then electric power to be generated by the high voltage generator is determined, as the high voltage side generation power, within a predetermined range depending on the high voltage side target power generation cost.

According to the present invention, it is possible to provide a vehicle-use dual voltage type power supply apparatus that can show a sufficiently high degree of effect of reducing fuel consumption by performing the electricity cost reduction type power generation control.

Other advantages and features of the invention will become apparent from the following description including the drawings and claims.

### BRIEF DESCRIPTION OF THE DRAWINGS

In the accompanying drawings:

FIG. 1 is a circuit diagram showing a circuit structure of a vehicle-use dual voltage type power supply apparatus according to an embodiment of the invention;

FIG. 2 is a characteristic diagram of a target power generation cost CP showing a relationship between a preferable SOC of a lead-acid battery and the target power generation cost CP;

FIG. 3 is a characteristic diagram of a target power generation cost CP showing a relationship between a preferable SOC of a lithium battery and the target power generation cost CP;

FIG. 4 is a characteristic diagram of a target power generation cost CP showing a relationship between a preferable SOC of a combined battery including a lead-acid battery and a lithium battery, and the target power generation cost CP;

FIG. 5 is a flowchart showing a electricity cost reduction type power generation control performed by the vehicle-use dual voltage type power supply apparatus;

FIG. 6 is a flowchart showing a subroutine for calculating a low voltage side electric power shortage;

FIG. 7 is a flowchart showing a subroutine for calculating a high voltage side electric power shortage;

FIGS. 8 to 11 are a flowchart showing a high voltage side preferential power distribution process;

FIGS. 12 to 19 are characteristic diagrams showing a relationship between a generation power W and a power generation cost Cg; and

FIG. 19 is a characteristic diagram showing relationships among an engine torque, a fuel consumption, and a power generation cost Cg.

### PREFERRED EMBODIMENTS OF THE INVENTION

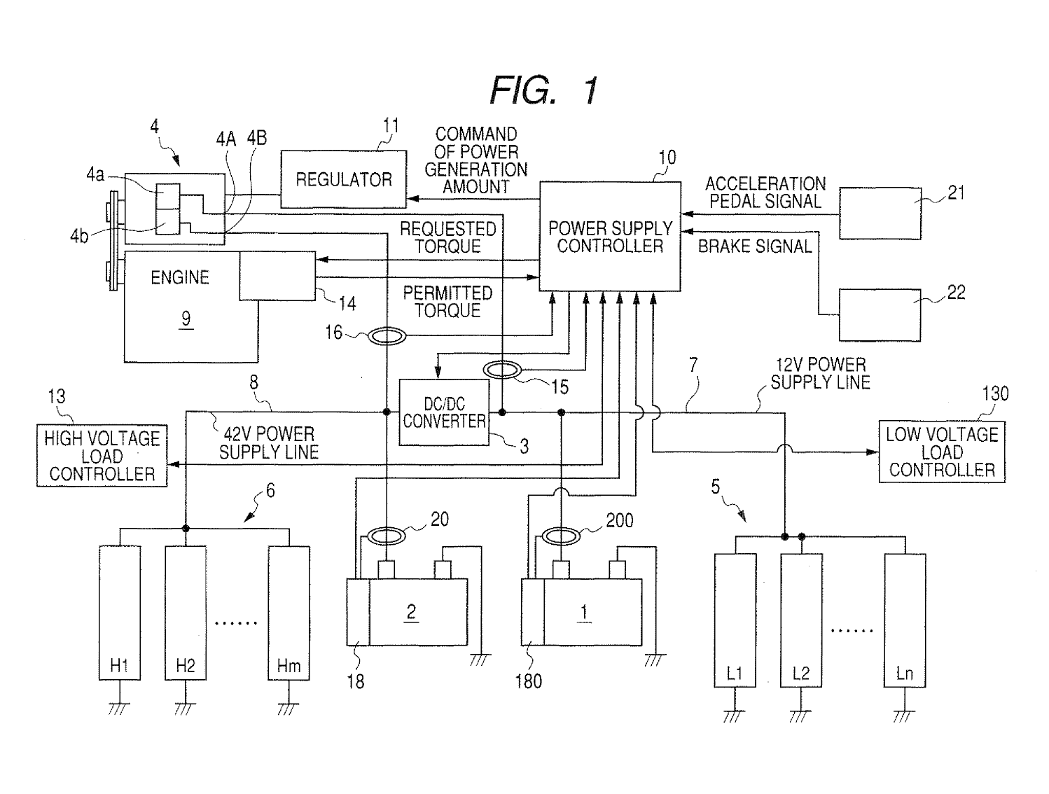

FIG. 1 is a diagram showing a circuit structure of a vehicle-use dual voltage type power supply apparatus according to an embodiment of the invention.

First, explanation is made as to power supply systems of the dual voltage type power supply apparatus.

In FIG. 1, the reference numeral 1 denotes a first battery whose rated voltage is 14V, 2 denotes a second battery whose rated voltage is 42V, 3 denotes a DC power transmission device performing electric power transmission between these batteries 1 and 2, 4 denotes a dual-voltage type generator outputting two different voltages as high and low power supply voltages, 5 denotes a low voltage load group including low voltage loads operating on the low power supply voltage, 6 denotes a high voltage load group including high voltage loads operating on the high power supply voltage, 7 denotes a low voltage power supply line, and 8 denotes a high voltage power supply line.

The dual voltage type generator 4 is constituted as a so-called tandem type generator that includes a low voltage generating section 4a and a high voltage generating section 4b both of which are driven by a vehicle engine 9 through a common rotating shaft.

The first battery 1, the low voltage generating section 4a, and the low voltage load group 5 constitute a low voltage power supply system. The second battery 2, the high voltage generating section 4b, and the high voltage load group 6 constitute a high voltage power supply system.

The first battery 1 is constituted by a lead-acid battery 14 with a rated voltage of 14V. The first battery 1 is connected to the low voltage power supply line 7 at its positive terminal, and grounded at its negative terminal. The low voltage power supply line 7, which is applied with the low power supply voltage outputted from a low voltage output terminal 4A of the dual voltage type generator 4, serves to supply electric power to the low voltage load group 5. The low voltage load group 5 is constituted by low voltage loads L1 to Ln required to operate on the low power supply voltage. The low voltage loads L1 to Ln include electronic devices such as communication devices, control devices, and broadcasting receivers.

The second battery 2 is constituted by a lithium rechargeable battery with a rated voltage of 42V that has less deterioration due to repetition of charging/discharging cycles than a lead-acid battery. The second battery 2 may be constituted by other charging means such as an electric double layer capacitor.

The high voltage power supply line 8, which is applied with the high power supply voltage outputted from a high voltage output terminal 4B of the dual voltage type generator 4, serves to supply electric power to the high voltage load group 6. The high voltage load group 6 is constituted by high voltage loads H1 to Hm required to operate on the high power supply voltage. The high voltage loads H1 to Hm include heaters, and motors such an air conditioner motor, and an electric power steering motor.

Although the DC power transmission device 3 is constituted by a DC/DC converter in this embodiment, it may be constituted by a switching regulator. The DC power transmission device 3 has a circuit structure enabling bidirectional power transmission. However, it may have a circuit structure enabling unidirectional power transmission. Since the circuit structure and operation of the DC/DC converter for bidirectionally or unidirectionally transmitting electric power are well known, no further explanation on the DC power transmission device 3 is given here.

Next, explanation is made as to a control system of the dual voltage type power supply apparatus. The control system includes a control device group and a sensor group as explained below.

In FIG. 1, the reference numeral 10 denotes a power supply controller, 11 denotes a regulator, 13 denotes a high voltage load controller, 14 denotes an engine controller, and 130 denotes a low voltage load controller. The power supply controller 10, regulator 11, high voltage load controller 13, engine controller 14, and low voltage load controller 130 constitute a control section of the dual voltage type power supply apparatus. The high voltage load controller 13 performs a centralized control of power distribution to the high voltage load group 6, and the low voltage load controller 130 performs a centralized control of power distribution to the low voltage load group 5.

The sensor group includes a current sensor 15 for detecting a generation current of the low voltage power supply system, a current sensor 16 for detecting a generation current of the high voltage power supply system, a second-battery state monitor 18 for detecting a state of the second battery 2, a first-battery state monitor 180 for detecting a state of the first battery 1, a current sensor 20 for detecting a charging/discharging current of the second battery 2, a current sensor 200 for detecting a charging/discharging current of the first battery 1, an accelerator sensor 21, and a brake sensor 22. The sensor group may include other sensors.

The current sensor 15 detects the generation current flowing from the low voltage generating section 4a of the dual voltage type generator 4 to the low voltage power supply line 7, and sends detected current data to the power supply controller 10. The current sensor 16 detects the generation current flowing from the high voltage generating section 4b of the dual voltage type generator 4 to the high voltage power supply line 8, and sends detected current data to the power supply controller 10.

Incidentally, if a three-phase inverter is used in place of a common diode type three-phase full wave rectifier for the high voltage generating section 4b of the dual voltage type generator 4, it becomes possible to cause the high voltage generating section 4b to operate as a motor to perform torque assist to the engine 9. In this case, the current sensor 16 detects an input current of the high voltage generating section 4b.

The second-battery state monitor 18 sends data indicative of a charging/discharging current of the second battery 2 detected by the current sensor 20, a temperature of the second battery 2, etc. to the power supply controller 10. In this embodiment, the second-battery state monitor 18 calculates an SOC of the second battery 2 on the basis of the detected charging/discharging current of the second battery 2 etc.

The first-battery state monitor 180 sends data indicative of a charging/discharging current of the first battery 1 detected by the current sensor 200, a temperature of the first battery 1, etc. to the power supply controller 10. In this embodiment, the first-battery state monitor 180 calculates an SOC of the first battery 1 on the basis of the detected charging/discharging current of the first battery 1 etc. The calculation of the SOCs may be performed by the power supply controller 10.

Depression amounts of an accelerator pedal and a brake pedal respectively detected by the accelerator sensor 21 and the brake sensor 22 are also sent to the power supply controller 10. Instead of the depression amount detected by the accelerator sensor 21, a throttle opening detected by a throttle sensor may be sent to the power supply controller 10. The power supply controller 10 makes a judgment as to whether a regenerative braking operation or a torque assist operation need to be performed on the basis of the depression amount of the accelerator pedal or brake pedal, and causes the high voltage generating section 4b of the dual voltage type generator 4 to operate as a generator or a motor in accordance with the result of the judgment.

The power supply controller 10 gives the regulator 11 a command of a power generation amount determined on the basis of data obtained from the sensor group, as well as data obtained from the high voltage load controller 13, low voltage load controller 130, and engine controller 14. The power supply controller 10 also gives the engine controller 14 a command of a requested torque necessary for the power generation, and gives the DC power transmission device 3 a command of a power transmission amount. In addition, the power apparatus controller 10 conducts data exchange with the high voltage load controller 13 in order to detect the states of the high voltage loads H1 to Hm and to perform a consumption power distribution control, and also conducts data exchange with the low voltage load controller 130 in order to detect the states of the low voltage loads L1 to Ln and to perform a consumption power distribution control. Incidentally, in the case of performing the torque assist operation, the power generation amount becomes negative.

The regulator 11 operates to control the power generation of the dual voltage type generator 4. In this embodiment, the dual voltage type generator 4 is a single-shaft tandem generator having the low voltage generating section 4a and the high voltage generating section 4b which can adjust their power generation amounts individually with each other. Accordingly, the power supply controller 10 produces a command of a low voltage power generation amount for the low voltage power supply system, and a command of a high voltage power generation amount for the high voltage power supply system.

These commands are calculated through the electricity cost reduction type power generation control which is explained in detail later.

The high voltage load controller 13 operates to adjust power consumptions of the high voltage loads H1 to Hm. Each of the high voltage loads H1 to Hm may be constituted by a plurality of electrical loads. In this embodiment, the high voltage load controller 13 has a circuit structure that individually controls power supply to the high voltage loads H1 to Hm. Alternatively, the high voltage load controller 13 may have a circuit structure that detects power consumption of each of the high voltage loads H1 to Hm. In a case where only a sum of the power consumptions of the high voltage loads H1 to Hm needs to be detected, although it is preferable to individually detect power consumptions of the high voltage loads H1 to Hm, it suffices to detect the difference between the value of the generation current detected by the current sensor 16 and the value of the charging/discharging current of the second battery 2 detected by the current sensor 20. However, in this case, any power transmission by the DC power transmission device 3 is not considered. In a case where the high voltage load controller 13 individually controls the high voltage loads H1 to Hm, the power consumption of each of the high voltage loads H1 to Hm may be adjusted by a simple on/off control, or a switching control. In this case, the high voltage load controller 13 may perform a precedence power distribution control in which the high voltage loads H1 to Hm are supplied with electric power in order of their precedence. In a case where adjustment of power consumptions of the high voltage loads H1 to Hm is not necessary, that is, the centralized power distribution control is not necessary, the high voltage load controller 13 may be eliminated.

The low voltage load controller 130 operates to adjust power consumptions of the low voltage loads L1 to Ln. Each of the low voltage loads L1 to Ln may be constituted by a plurality of electrical loads. In this embodiment, the low voltage load controller 130 has a circuit structure that individually controls power supply to the low voltage loads L1 to Ln. Alternatively, the low voltage load controller 130 may have a circuit structure that detects power consumption of each of the low voltage loads L1 to Ln. In a case where only a sum of the power consumptions of the low voltage loads L1 to Ln need to be detected, although it is preferable to individually detect power consumptions of the low voltage loads L1 to Ln, it suffices to detect the difference between the value of the generation current detected by the current sensor 15 and the value of the charging/discharging current of the first battery 1 detected by the current sensor 200. However, in this case, any power transmission by the DC power transmission device 3 is not considered. In a case where the low voltage load controller 130 individually controls the low voltage loads L1 to Ln, the power consumption of each of the low voltage loads L1 to Ln may be adjusted by a simple on/off control, or a switching control. In this case, the low voltage load controller 130 may perform a precedence power distribution control in which the low voltage loads L1 to Ln are supplied with electric power in order of their precedence. In a case where adjustment of consumptions of the low voltage loads L1 to Ln is not necessary, that is, the centralized power distribution control is not necessary, the low voltage load controller 130 may be eliminated.

The engine controller 14 receives a target power generation cost (to be explained later) from the power supply controller 10, calculates a permitted torque range indicative of a range of torque assigned to the dual voltage type generator 4 to attain the target power generation cost, and sends the calculated permitted torque range to the power supply controller 10.

The power supply controller 10 determines a requested torque to be assigned to the dual voltage type generator 4 within the received permitted torque range, and sends this requested torque to the engine controller 14. The engine controller 14 control fuel supply to the engine so that an engine torque corresponding to the requested torque is generated to drive the dual voltage type generator 4.

The power supply controller 10 sends, to the regulator 11, the above described command of a high voltage power generation amount, and the above described command of a low voltage power generation amount depending on a generation power amount generatable by the requested torque sent to the engine controller 14. The regulator 11 commands the low voltage generating section 4a to generate power by an amount indicated by the command of the low voltage power generation amount, and commands the high voltage generating section 4b to generate power by an amount indicated by the command of the high voltage power generation amount.

The power supply controller 10 also performs control for electric power accommodation between the low voltage power supply system and the high voltage power supply system.

Next, explanation is made as to the electricity cost reduction type power generation control.

First, the basic concept of the electricity cost reduction type power generation control is explained briefly.

In the electricity cost reduction type power generation control, the power generation is controlled by use of a power generation cost Cg, and a target power generation cost CP.

The power generation cost Cg means a cost for the generator to produce a unit electric power. For example, it can be represented by an amount of fuel consumed to produce an electric power of 1 kWh. The power generation cost Cg varies depending on an engine running state. That is, the power generation cost Cg varies depending on a rotational speed of the engine, and an engine torque. By storing, in advance, a map showing a relationship between the engine state and the power generation cost Cg, it becomes possible to calculate the power generation cost Cg from the current engine state.

The target power generation cost CP is defined as a function of the SOC of the battery serving as a power supply means-cum-power consuming means. This function may be referred to as a target power generation cost function hereinafter. In other words, the target power generation cost CP is a power generation cost of the battery, or a battery electricity cost when the battery is assumed to be a power generating means. When the target power generation cost CP (or the battery electricity cost) is lower than the power generation cost of the generator, the power generation amount of the generator should be reduced, and the discharging current of the battery should be increased. When the target power generation cost CP (or the battery electricity cost) is higher than the power generation cost of the generator, the power generation amount of the generator should be increased, and the discharging current of the battery should be reduced. It is a matter of course that the battery preferably should be operated within a moderate range of the SOC of the battery.

Accordingly, when the SOC of the battery deviates from this range toward the charging side, it is preferable to discharge the battery, and when the SOC of the battery deviates from this range toward the discharging side, it is preferable to charge the battery. Discharging the battery should cause reduction of the power generation amount of the generator, and charging the battery should cause increase of power generation amount of the generator.

Accordingly, the target power generation cost function (that is, the target power generation cost CP) is set so as to have negative correlation with the SOC. Hence, when the SOC is low, the target power generation cost CP becomes high, and when the SOC is high, the target power generation cost CP becomes low. This embodiment may be so configured as to learn an optimum curve of the target power generation cost function on the basis of a history of the results of the control.

By calculating the target power generation cost CP and the power generation cost Cg, comparing them with each other, and adjusting the power generation amount of the generator in accordance with comparison result, it becomes possible to perform such a control that when the power generation cost Cg is considerably low (for example, when a regenerative braking operation is performed), the power generation amount of the generator is substantially increased to charge the battery, and when the power generation cost Cg is considerably high (for example, when the vehicle is climbing a steep slope), the power generation amount of the generator is substantially reduced to discharge the battery.

A most simple configuration to apply the above described electricity cost reduction type power generation control to a vehicle power supply system including two batteries of different types is such that these two batteries are assumed to constitute a combined battery, the target power generation cost CP is calculated depending on the SOC of this combined battery, and the target power generation cost CP is compared with the power generation cost Cg.

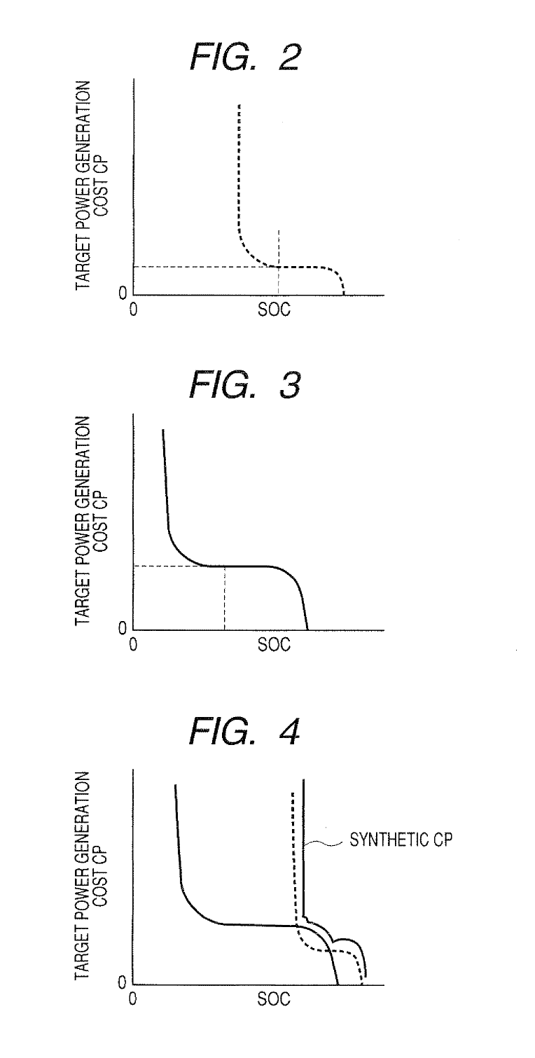

However, it has turned out that this configuration involves the following problem. These batteries have different SOC values, and their preferred SOC ranges differ from each other due to differences in the battery type, and the aged deterioration. FIG. 2 shows a preferable characteristic curve of the target power generation cost CP with respect to SOC in the case of a lead-acid battery is used, and FIG. 3 shows a preferable characteristic curve of the target power generation cost CP with respect to SOC in the case of a lithium battery is used. As seen from these Figs., a preferred SOC range of the lead-acid battery is narrow for the necessity to suppress aged deterioration, while that of the lithium battery is wide.

Accordingly, if the electricity cost reduction type power generation control is performed assuming that the vehicle power supply system has one combined battery although actually it has two batteries of different types, a preferred SOC range becomes very narrow as shown in FIG. 4, because both of the two batteries should operate in good conditions within this SOC range. This means that the storage capacity of the lithium battery cannot be effectively utilized.

Furthermore, two generators in such a vehicle power supply system have different performance characteristics. For example, they have different power generation efficiencies. Accordingly, according to such a simple configuration as described above, the effect of the electricity cost reduction type power generation control can be obtained only insufficiently.

Next, the electricity cost reduction type power generation control performed by the dual voltage type power supply apparatus of this embodiment is explained. In order to remove the problem in the above configuration in which the two batteries and the two generators are equated to a single battery and a single generator, respectively, this embodiment is so configured as to perform the electricity cost reduction type power generation control for each of the high voltage power supply system and the low voltage power supply system by use of different target power generation costs.

To be in more detail, the target power generation cost is calculated individually for each of the two power supply systems in accordance with SOC as a variable of its own battery, so that the electricity cost reduction type power generation control can be performed individually for each of the two power supply systems. And by appropriately distributing the electric power generated on that basis to the two power supply systems, it becomes possible to obtain, to the maximum extent possible, the effect of fuel consumption reduction by the electricity cost reduction type power generation control.

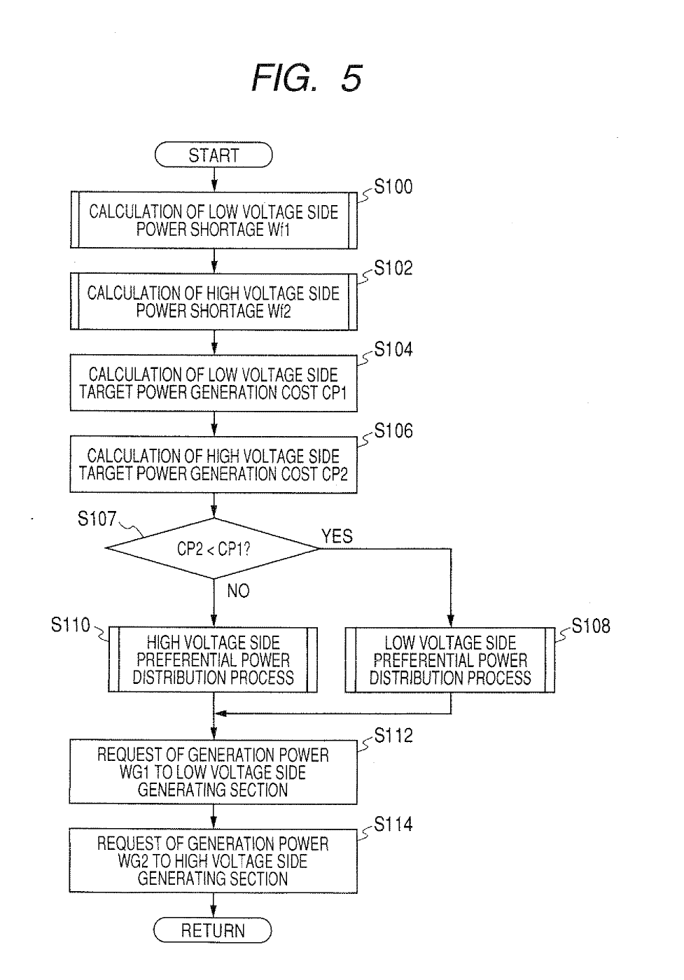

Next, explanation is made as to a specific example of the electricity cost reduction type power generation control with reference to the flowchart of FIG. 5.

The electricity cost reduction type power generation control begins by calculating, at steps S100, 3102, an electric power shortage Wf1 in the low voltage power supply system (may be referred to as “low voltage side power shortage Wf1” hereinafter), and an electric power shortage Wf2 in the high voltage power supply system (may be referred to as “high voltage side power shortage Wf2” hereinafter). The routine for this calculation is explained later.

After that, a target power generation cost CP1 in the low voltage power supply system (may be referred to as “low voltage side target power generation cost CP1” hereinafter), and a target power generation cost CP2 in the high voltage power supply system (may be referred to as “high voltage side target power generation cost CP2” hereinafter) are calculated at steps S104, S106, respectively.

The method of these calculations is basically as described above. Here, the low voltage side target power generation cost CP1 is calculated on the basis the SOC of the battery 1 calculated by a conventionally known method with reference to the prestored map shown in FIG. 2, and the high voltage side target power generation cost CP2 is calculated on the basis of the SOC of the battery 2 calculated in a like manner with reference to the prestored map shown in FIG. 3.

Next, a comparison is made between the high voltage side target power generation cost CP2 and the low voltage side target power generation cost CP1 at step S107. If the high voltage side target power generation cost CP2 is lower than the low voltage side target power generation cost CP1, a low voltage side preferential power distribution process (to be explained later) is performed at step S108, and otherwise, a high voltage side preferential power distribution process (to be explained later) is performed at step S110.

Thereafter, the low voltage generating section 4a is commanded at step S112 to generate electric power by an amount indicated by a low voltage side requested power generation value WG1 determined by the above described low voltage side preferential power distribution process, and the high voltage generating section 4b is commanded at step S114 to generate electric power by an amount indicated by a high voltage side requested power generation value WG2 determined by the above described high voltage side preferential power distribution process. And then, this routine (the electricity cost reduction type power generation control) is terminated, and return to a main routine is made. The routine shown in FIG. 5 is performed at regular short intervals.

As explained above, this routine optimally adjusts the low voltage side requested power generation value WG1 and the high voltage side requested power generation value WG2 by selecting from between the low voltage side preferential power distribution process and the high voltage side preferential power distribution process.

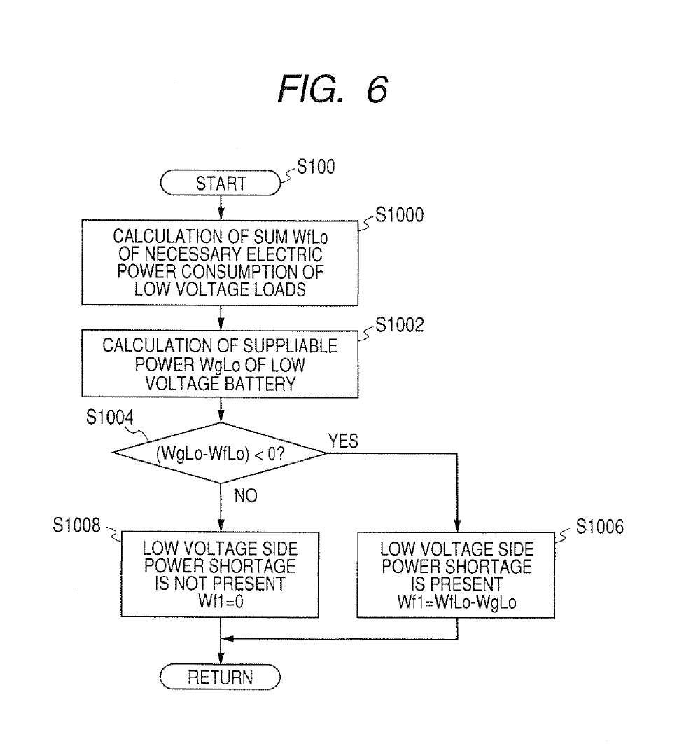

Next, explanation is made as to an example of the process of the calculation of the low voltage side power shortage Wf1 performed at step S100 with reference to the flowchart shown in FIG. 6.

This calculation process starts by calculating, at step S1000, a sum WfLo of electric power consumptions of the low voltage load group 5 including the low voltage loads L1 to Ln (may be referred to as low voltage side total power consumption WfLo) on the basis of the operation states of the low voltage loads L1 to Ln. Subsequently, a low voltage side suppliable battery power WgLo indicative of electric power which the battery 1 can supply to the low voltage load group 5 is calculated on the basis of the remaining capacity of the battery 1 at step S1002. This calculation can be made by any known method. For example, a map showing a relationship between the SOC and WgLo of the battery 1 may be stored in advance.

After that, a comparison between the sum WfLo and the low voltage side suppliable battery power WgLo is made at step S1004. If the low voltage side suppliable battery power WgLo is smaller than the low voltage side total power consumption WfLo, a flag is set to “1” to indicate that there is a low voltage side electric power shortage Wf1 (=WfLo−WgLo) at step S1006, and otherwise the flag is set to “0” at step S1008.

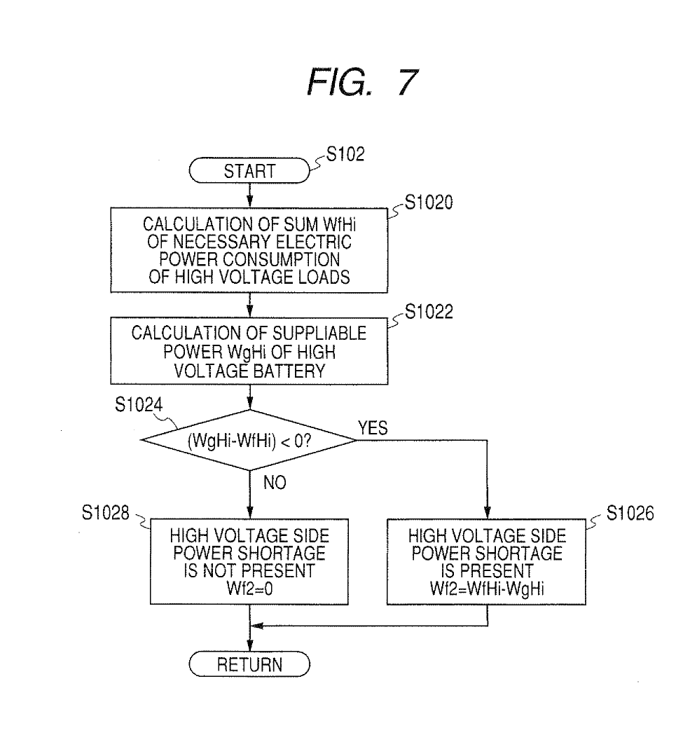

Next, explanation is made as to an example of the process of the calculation of the high voltage side power shortage Wf2 performed at step S102 with reference to the flowchart shown in FIG. 7.

This calculation process starts by calculating, at step S1020, a sum WfHi of electric power consumptions of the high voltage load group 6 including the high voltage loads H1 to Hm (may be referred to as high voltage side total power consumption WfHi) on the basis of the operation states of the high voltage loads H1 to Hm. Subsequently, a high voltage side suppliable battery power WgHi indicative of electric power which the battery 2 can supply to the high voltage load group 6 is calculated on the basis of the remaining capacity of the battery 2 at step S1022. This calculation can be made by any known method. For example, a map showing a relationship between the SOC and WgHi of the battery 2 may be stored in advance.

After that, a comparison between the sum WfHi and the high voltage side suppliable battery power WgHi is made at step S1024. If the high voltage side suppliable battery power WgHi is smaller than the high voltage side total power consumption WfHi, a flag is set to “1” to indicate that there is a high voltage side electric power shortage Wf2 (=WfHi−WgHi), and otherwise the flag is set to “0” at step S1028.

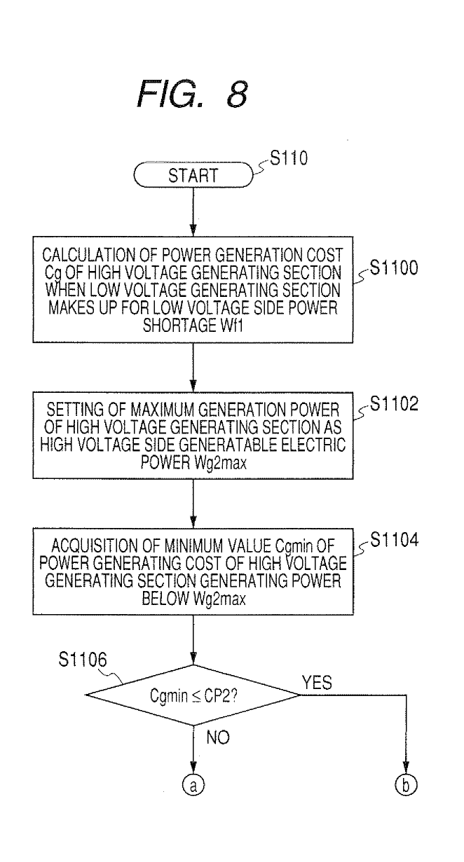

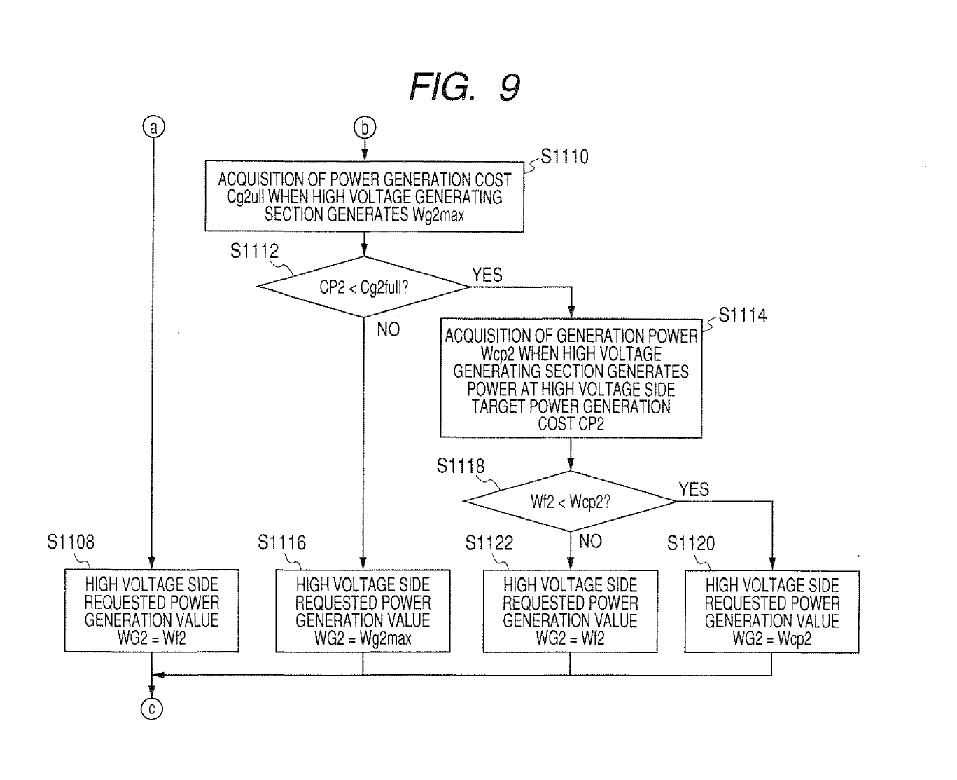

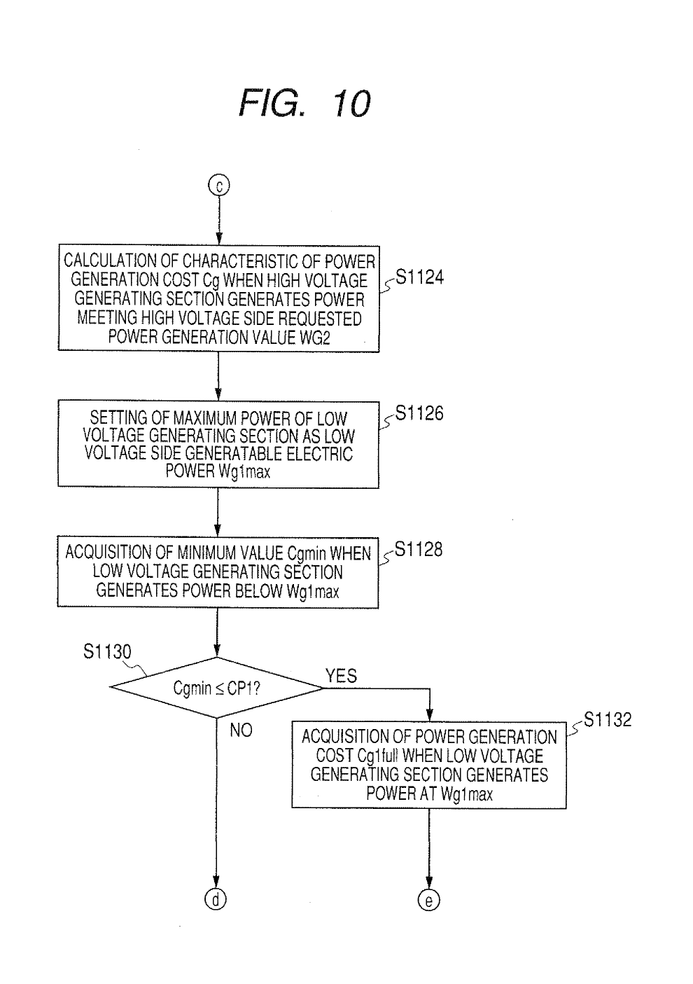

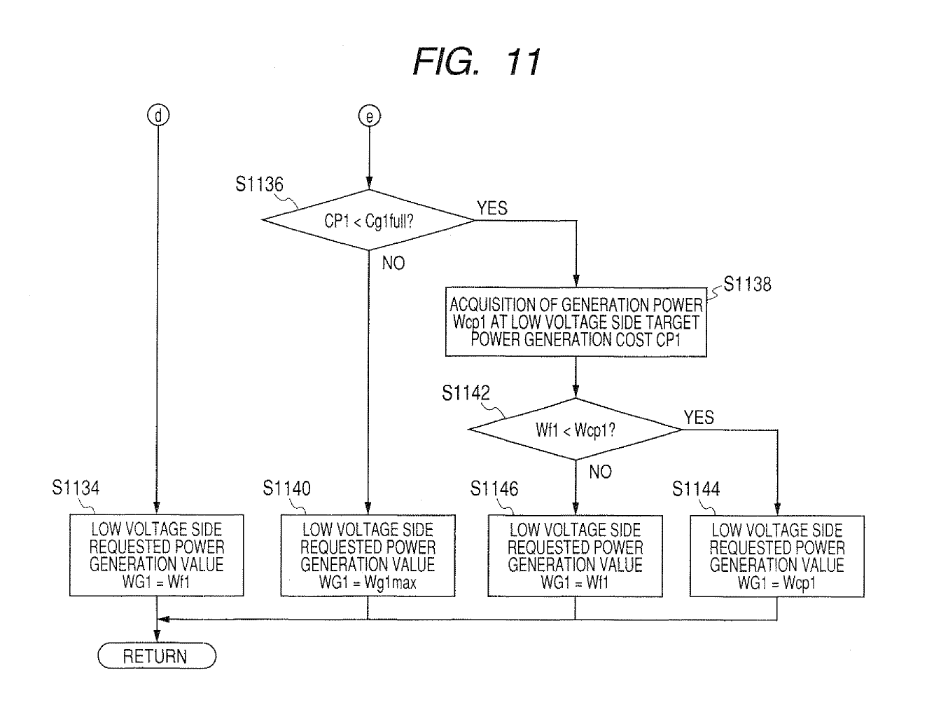

Next, explanation is made as to the high voltage side preferential power distribution process performed at step 110 with reference to the flowchart shown in FIGS. 8 to 11.

This process starts by calculating, at step S1100, a characteristic of the power generation cost Cg of the generator 4 when the low voltage generating section 4a generates electric power to make up for the low voltage side power shortage Wf1.

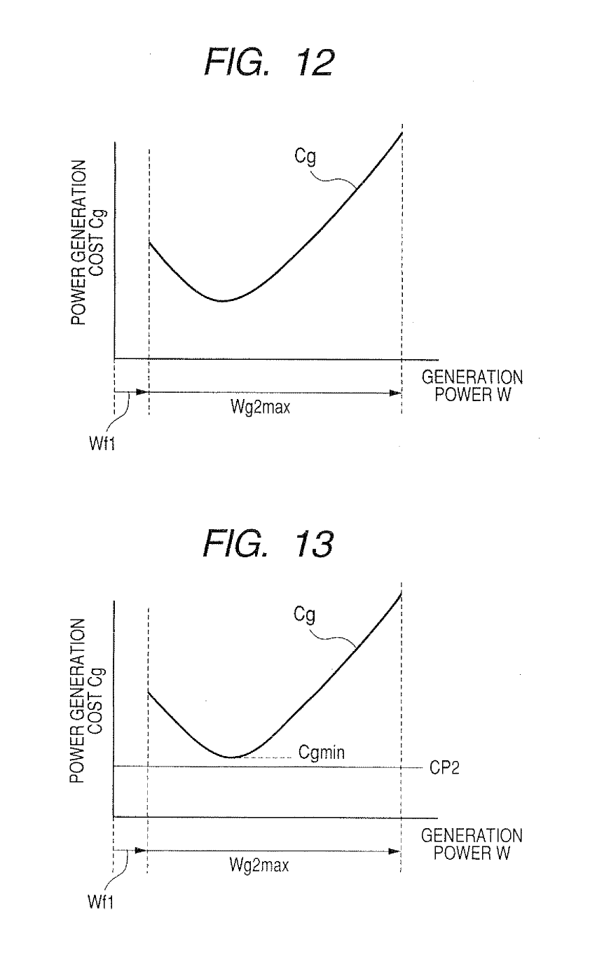

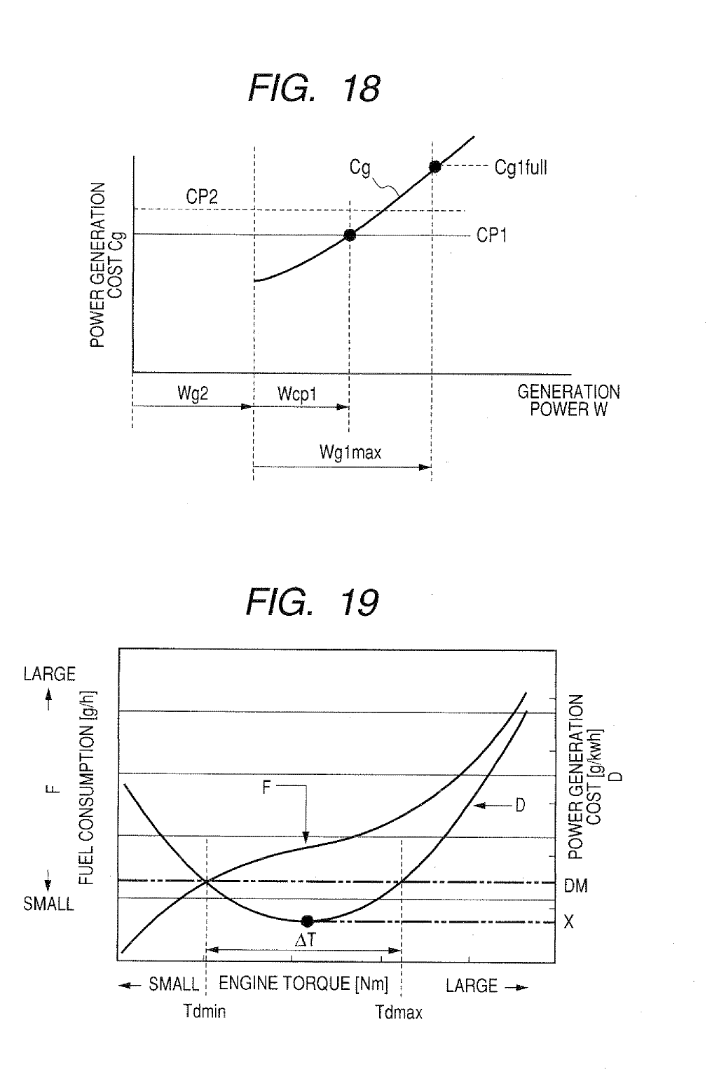

The power generation cost Cg is equivalent to an amount of fuel consumed to produce a unit electric power at the engine operating point determined by an engine torque equal to a sum of a load torque corresponding to a sum of the electric power being generated by the high voltage generating section 4b and the low voltage side power shortage Wf1, and a current driving torque, and by a current engine speed. Accordingly, in this embodiment, a map (for example, a map shown in FIG. 19) showing relationships among the above described parameters is stored in advance, and there is obtained, by referring to this map, a relationship between the power generation cost Cg and the generation power of the generator 4 when the low voltage generating section 4a generates electric power equal to the low voltage side power shortage Wf1, and the high voltage generating section 4b generates the high voltage side generation power. The obtained relationship makes the above described characteristic of the power generation cost Cg. FIG. 12 shows an example of this characteristic.

After that, a maximum power of the high voltage generating section 4b is set as a high voltage side generatable electric power Wg2max (see FIG. 12) at step S1102. And then, a minimum value of the power generation cost Cg of the high voltage generating section 4b in a range below the high voltage side generatable electric power Wg2max is obtained as a minimum value Cgmin of the power generation cost Cg (see FIG. 13) from the above described characteristic at step S1104.

Next, there is made a comparison between the obtained minimum value Cgmin of the power generation cost Cg and the target power generation cost CP2 in the high voltage side power supply system at step S1106. If the minimum value Cgmin of the power generation cost Cg is smaller than the target power generation cost CP2, this process proceeds to step S1110, and otherwise proceeds to step S1108.

At step S1108, the high voltage side requested power generation value WG2 indicative of electric power which the high voltage generating section 4b is requested to generate is set at the high voltage side electric power shortage Wf2. Hence, the high voltage power supply system is supplied with electric power only by an amount of the high voltage side electric power shortage Wf2, or a minimum electric power which the high voltage power supply system needs.

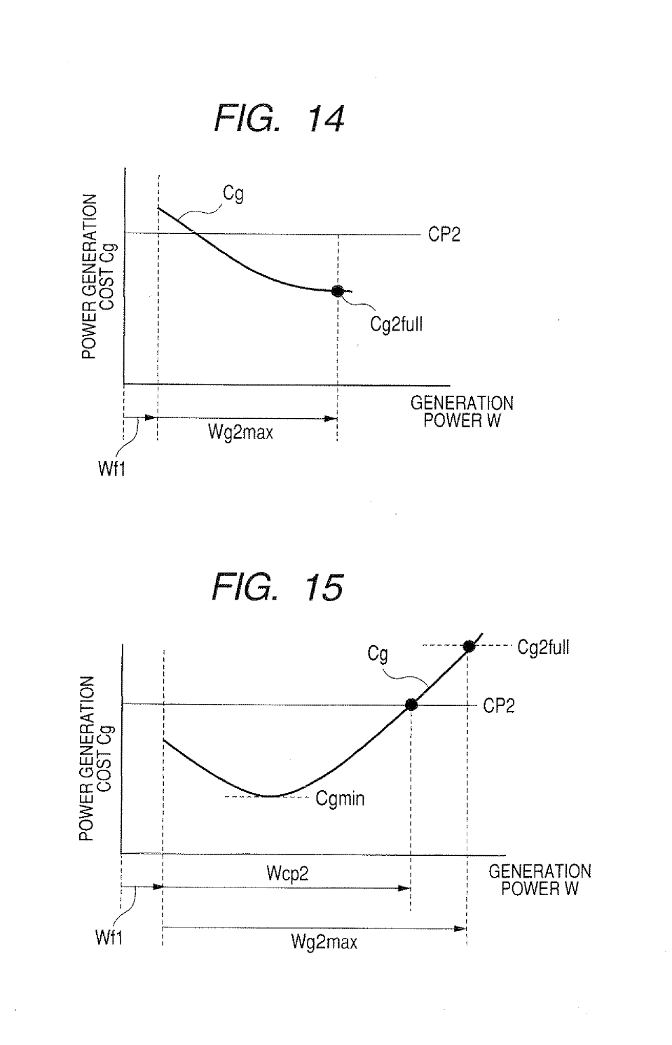

At step S1110, there is calculated the power generation cost Cg of the high voltage generating section 4b when the generation power of the high voltage generating section 4b is assumed to be the high voltage side generatable electric power Wg2max on the basis of the above described characteristic, and this calculated power generation cost Cg is set as a power generation cost Cg2full. And then, the process proceeds to step S1112 (see FIG. 14).

At step S1112, a comparison between the power generation cost Cg2full and the target power generation cost CP2 in the high voltage power supply system is made. If the target power generation cost CP2 is lower than the generation cost Cg2full, the process proceeds to step S1114, and otherwise proceeds to step s1116.

At step S1108, the high voltage side requested power generation value WG2 indicative of electric power which the high voltage generating section 4b is requested to generate is set as the high voltage side generatable electric power Wg2max. Thus, a maximum electric power which the high voltage generating section 4b can generate is requested.

At step S1114, electric power generated at a point of the target power generation cost CP2 obtained at step S106 in the map (see FIG. 15) is set as a generation power Wcp2. This generation power Wcp2 means electric power which the high voltage generating section 4b can generate meeting the target power generation cost CP2.

Subsequently, a comparison between the high voltage side electric power shortage Wf2 and the generation power Wcp2 is made at step S1118. If the high voltage side electric power shortage Wf2 is smaller than the generation power Wcp2, the process proceeds to step S1120 to set the high-voltage side requested power generation value WG2 as the generation power Wcp2, and otherwise, proceeds to step S1122 to set the high voltage side requested power generation value WG2 as the high voltage side electric power shortage Wf2. Thus, the high voltage power supply system is supplied with only the high voltage side electric power shortage Wf2, that is, a minimum electric power which the high voltage power supply system needs.

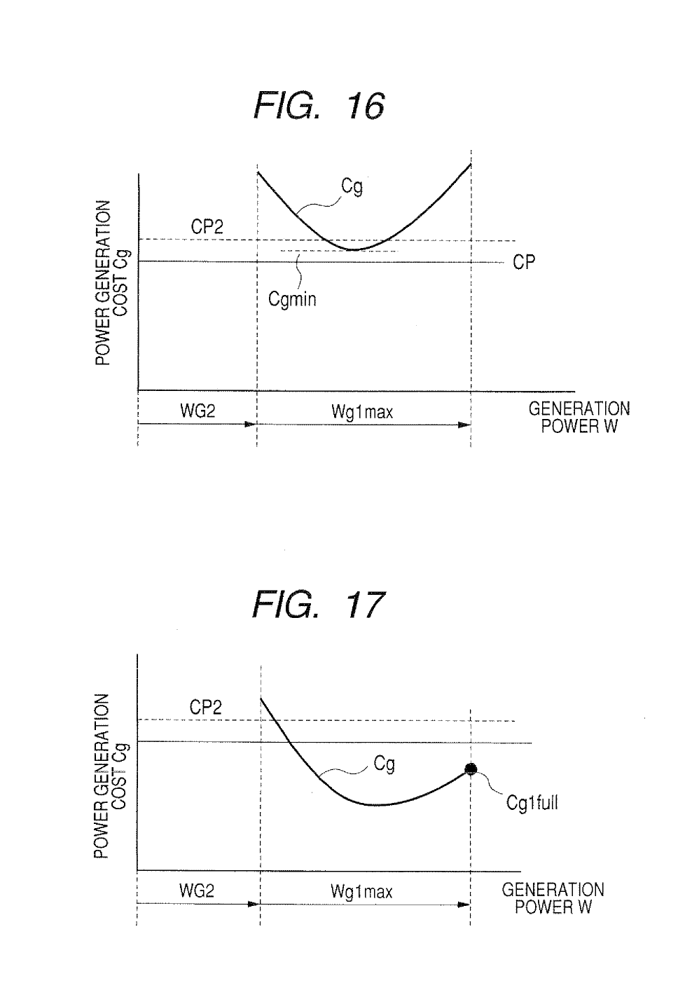

At subsequent step S1124, there is calculated a characteristic of the power generation cost Cg of the generator 4 when the high voltage generating section 4b generates electric power to meet the high voltage side requested power generation value WG2. The power generation cost Cg is equivalent to an amount of fuel consumed to produce a unit electric power at the engine operating point determined by an engine torque equal to a sum of a load torque corresponding to a sum of the electric power being generated by the low voltage generating section 4a and the high voltage side requested power generation value WG2, and a current driving torque, and by a current engine speed. Accordingly, in this embodiment, a map (for example, the map shown in FIG. 19) showing relationships among the above described parameters is stored in advance, and there is obtained, by referring to this map, a relationship between the generation power of the generator 4 and the power generation cost Cg of the low voltage generating section 4a when the low voltage generating section 4b generates electric power by the high voltage side requested power generation value WG2. The obtained relationship makes the above described characteristic of the power generation cost Cg. FIG. 16 shows an example of this characteristic.

After that, a maximum power of the low voltage generating section 4a is set as a low voltage side generatable electric power Wg1max at step S1126. And then, a minimum value of the power generation cost Cg of the low voltage generating section 4a in a range below the low voltage side generatable electric power Wg1max is obtained as a minimum value Cgmin of the power generation cost Cg from the above described characteristic (see FIG. 16) at step S1128.

Next, a comparison between the obtained minimum value Cgmin of the power generation cost Cg and the target power generation cost CP1 of the low voltage side power supply system is made at step S1130. If the minimum value Cgmin of the power generation cost Cg is smaller than the target power generation cost CP1, the process proceeds to step S1132, and otherwise proceeds to step S1134.

At step S1134, the low voltage side requested power generation value WG1 indicative of electric power which the low voltage generating section 4a is requested to generate is set at the low voltage side electric power shortage Wf1. Hence, the low voltage power supply system is supplied with electric power only by an amount of the low voltage side electric power shortage Wf1, or a minimum electric power which the low voltage power supply system needs.

At step S1132, there is calculated the power generation cost Cg when the generation power of the low voltage generating section 4a is assumed to be the low voltage side generatable electric power Wg1max on the basis of the above described characteristic, and this calculated power generation cost Cg is set as a power generation cost Cg1full. And then, the process proceeds to step S1136 (see FIG. 17).

At step S1136, a comparison between the power generation cost Cg1full and the target power generation cost CP1 in the low voltage power supply system is made. If the target power generation cost CP1 is lower than the power generation cost Cg2full, the process proceeds to step S1138, and otherwise proceeds to step s1140.

At step S1140, the low voltage side requested power generation value WG1 indicative of electric power which the low voltage generating section 4a is requested to generate is set as the low voltage side generatable electric power Wg1max. Thus, a maximum electric power which the low voltage generating section 4a can generate is requested.

At step S1138, a generation power at a point of the target power generation cost CP1 in the low voltage power supply system calculated at step S104 is obtained from the map as a generatable power Wcp1 (see FIG. 18). This generatable power Wcp1 means electric power which the low voltage generating section 4a can generate at a point of the target power generation cost CP1.

Subsequently, a comparison between the low voltage side electric power shortage Wf1 and the generatable power Wcp1 is made at step S1142. If the low voltage side electric power shortage Wf1 is smaller than the generatable power Wcp1, the process proceeds to step S1144 to set the low voltage side requested power generation value WG1 as this generatable power Wcp1, and otherwise, proceeds to step S1146 to set the low voltage side requested power generation value WG1 as the low voltage side electric power shortage Wf1. Hence, the low voltage power supply system is supplied with only the low voltage side electric power shortage Wf1, that is, a minimum electric power which the low voltage power supply system needs.

As explained above, in the above described high voltage side preferential power distribution process, the electricity cost reduction type power generation control is performed preferentially on the side of the high voltage power supply system to promote electric power generation in a range below the target power generation cost CP2, while the electricity cost reduction type power generation control is performed on the side of the low voltage power supply system to promote electric power generation at the target power generation cost CP1. And also there is performed a control for supplying each of these systems with their minimum necessary electric power irrespective of the result of comparison between the target power generation cost CP and the power generation cost Cg.

Thus, according to this embodiment, the electricity cost reduction type power generation control can be optimally performed in a comprehensive manner in the dual voltage type power supply apparatus.

In the above explanation, although the power generation cost Cg of the high voltage generating section 4b has been described as being substantially the same as the power generation cost Cg of the low voltage generating section 4a, they may be calculated differently.

The details of the low voltage side preferential power distribution process performed at step S108 are basically the same as those shown in the flowchart explaining the high voltage side preferential power distribution process in which the term “high voltage” and the term “low voltage” has been exchanged.

The above explained preferred embodiments are exemplary of the invention of the present application which is described solely by the claims appended below. It should be understood that modifications of the preferred embodiments may be made as would occur to one of skill in the art.

What is claimed is:

1. A vehicle-use dual voltage type power supply apparatus comprising:
a high voltage generator driven by a vehicle engine;
a low voltage generator driven by said vehicle engine;
a high voltage battery charged by said high voltage generator and connected with a high voltage load;
a low voltage battery charged by said low voltage generator and connected with a low voltage load; and
a control section controlling power generating operations of said high voltage generator and said low voltage generator;
said high voltage generator and said high voltage battery constituting a high voltage power supply system, and said low voltage generator and said low voltage battery constituting a low voltage power supply system,
wherein said control section
stores therein, as a low voltage side cost-SOC correlation, a negative correlation between a low voltage side target power generation cost and an SOC of said low voltage battery,
stores therein, as a high voltage side cost-SOC correlation, a negative correlation between a high voltage side target power generation cost and an SOC of said high voltage battery,
determines said SOC of said high voltage battery based on a charging/discharging current of said high voltage battery, and said SOC of said low voltage battery based on a charging/discharging current of said low voltage battery,
determines said low voltage side target power generation cost based on said low voltage side cost-SOC correlation and said SOC of said low voltage battery, and said high voltage side target power generation cost based on said high voltage side cost-SOC correlation and said SOC of said high voltage battery,
performs a comparison between said low voltage side target power generation cost and said high voltage side target power generation cost,
when said high voltage side target power generation cost is lower than said low voltage side target power generation cost, performs a high voltage side preferential power distribution process in which electric power to be generated by said high voltage generator is determined, as a high voltage side generation power, within a predetermined range depending on said high voltage side target power generation cost, and then electric power to be generated by said low voltage generator is determined, as a low voltage side generation power, within a predetermined range depending on said low voltage side target power generation cost, and
when said high voltage side target power generation cost is not lower than said low voltage side target power generation cost, performs a low voltage side preferential power distribution process in which electric power to be generated by said low voltage generator is determined, as said low voltage side generation power, within a predetermined range depending on said low voltage side target power generation cost, and then electric power to be generated by said high voltage generator is determined, as said high voltage side generation power, within a predetermined range depending on said high voltage side target power generation cost.

2. The vehicle-use dual voltage type power supply apparatus according to claim 1, wherein said control section
calculates, in advance, a low voltage side power shortage indicative of a shortage difference between a dischargeable power of said low voltage battery and a power consumption of said low voltage load,
determines, at the time of performing said high voltage side preferential power distribution process, a characteristic of a first power generation cost of said high voltage generator for a case where said high voltage generator generates electric power by an amount of said low voltage side power shortage depending on a running state of said vehicle engine, and
determines said high voltage side generation power in accordance with a result of a comparison between said first power generation cost of said high voltage generator and said high voltage side target power generation cost.

3. The vehicle-use dual voltage type power supply apparatus according to claim 2, wherein said control section
calculates a high voltage side power shortage indicative of a shortage difference between a dischargeable power of said high voltage battery and a power consumption of said high voltage load,
determines, at the time of performing said high voltage side preferential power distribution process, a minimum value of said first power generation cost of said high voltage generator for a case where said low voltage generator generates electric power to make up for said low voltage side power shortage, and said high voltage generator generates electric power in a range below a maximum generatable electric power thereof on the basis of said characteristic,
performs a comparison between said minimum value and said high voltage side target power generation cost, and
when said minimum value is larger than said high voltage side target power generation cost, sets said high voltage side generation power at a value substantially equal to said high voltage side power shortage.

4. The vehicle-use dual voltage type power supply apparatus according to claim 3, wherein, at the time of performing said high voltage side preferential power distribution process, said control section
determines a second power generation cost of said high voltage generator for case where said high voltage generator generates a maximum generatable electric power thereof on the basis of said characteristic and
when said high voltage side target power generation cost is higher than said second power generation cost of said high voltage generator, sets said high voltage side generation power at a value substantially equal to said maximum generatable electric power.

5. The vehicle-use dual voltage type power supply apparatus according to claim 4, wherein, at the time of performing said high voltage side preferential power distribution process, said control section
determines, electric power which said high voltage generator can generate meeting said high voltage side target power generation cost on the basis of said characteristic,
performs comparison between said determined electric power and said high voltage side power shortage, and
when said high voltage side power shortage is larger than said determined electric power, sets said high voltage side generation power at a value substantial equal to said high voltage side power shortage.

6. The vehicle-use dual voltage type power supply apparatus according to claim 5, wherein, when said high voltage side power shortage is smaller than said determined electric power, said control section sets, at the time of performing said high voltage side preferential power distribution process, said high voltage side generation power at a value substantially equal to said determined electric power.

7. The vehicle-use dual voltage type power supply apparatus according to claim 3, wherein said control section determines, as a low voltage side generation power, electric power to be generated by said low voltage generator after determining said high voltage side generation power by performing said high voltage side preferential power distribution process.

8. The vehicle-use dual voltage type power supply apparatus according to claim 7, wherein, at the time of performing said high voltage side preferential power distribution process, said control section
determines, a characteristic of a first power generation cost of said low voltage generator for a case where said high voltage generator generates said high voltage side generation power on the basis of a running state of said vehicle engine,
determines a minimum value of said first power generation cost of said low voltage generator for a case where said low voltage generator generates electric power in a range below a maximum generatable power thereof,
performs a comparison between said minimum value of said first power generation cost of said low voltage generator, and said low voltage side target power generation cost, and
when said minimum value of said first power generation cost of said low voltage generator is higher than said low voltage side target power generation cost, sets said low voltage side generation power at a value substantially equal to said low voltage side power shortage.

9. The vehicle-use dual voltage type power supply apparatus according to claim 8, wherein, at the time of performing said high voltage side preferential power distribution process, said control section
determines a second power generation cost of said low voltage generator for a case where said low voltage generator generates a maximum generatable electric power thereof on the basis of said characteristic of said first power generation cost of said low voltage generator, and
when said low voltage side target power generation cost is higher than said second power generation cost of said low voltage generator, sets said low voltage side generation power at a value substantially equal to said maximum generatable electric power of said low voltage generator.

10. The vehicle-use dual voltage type power supply apparatus according to claim 9, wherein, at the time of performing said high voltage side preferential power distribution process, said control section
determines, electric power which said low voltage generator can generate meeting said second low voltage side target power generation cost of said low voltage generator on the basis of said characteristic of said first power generation cost of said low voltage generator,
performs comparison between said determined electric power and said low voltage side power shortage, and
when said low voltage side power shortage is larger than said determined electric power, sets said low voltage side generation power at a value substantially equal to said low voltage side power shortage.

11. The vehicle-use dual voltage type power supply apparatus according to claim 10, wherein, at the time of performing said high voltage side preferential power distribution process,
when said low voltage side power shortage is smaller than said determined electric power, said control section sets said low voltage side generation power at a value substantially equal to said determined electric power.

12. The vehicle-use dual voltage type power supply apparatus according to claim 1, wherein, at the time of performing said high voltage side preferential power distribution process and at the time of performing said low voltage side preferential power distribution process
said control section determines, by referring to a prestored relationship between a sum of a power generation amount of said low voltage generator and a power generation amount of said high voltage generator and a power generation cost of one of said high voltage generator and said low voltage generator, a power generation cost of one of said high voltage generator and said low voltage generator depending on a current power generation amount of the other of said high voltage generator, when said current power generation amount is assumed to be at a constant value.
